(19) United States
(12) Patent Application Publication
(10) Pub. No.: US 2026/0230293 A1
(43) Pub. Date: Aug. 6, 2026

(54) MULTIPLE TIME DIVISION DUPLEX PATTERNS FOR A TIME INTERVAL

(71) Applicant: QUALCOMM Incorporated, San Diego, CA (US)

(72) Inventors: Lianghai JI, San Diego, CA (US); Alberto RICO ALVARINO, San Diego, CA (US); Qiang WU, San Diego, CA (US); Mehmet Izzet GURELLI, San Diego, CA (US)

(21) Appl. No.: 19/047,211

(22) Filed: Feb. 6, 2025

(51) Int. Cl. H04L 5/14; H04L 5/00

(52) U.S. Cl. CPC H04L 5/14; H04L 5/0053

(57) ABSTRACT

Various aspects of the present disclosure generally relate to wireless communication. In some aspects, a first network entity may receive a first message that indicates multiple time division duplex (TDD) patterns that are each associated with one or more first time intervals, wherein the one or more first time intervals are associated with a periodic pattern. The first network entity may communicate a second message in accordance with a TDD pattern of the multiple TDD patterns. Numerous other aspects are described.

### FIELD OF THE DISCLOSURE

Aspects of the present disclosure generally relate to wireless communication and specifically relate to techniques, apparatuses, and methods associated with multiple time division duplex patterns for a time interval.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless communication systems may include a non-terrestrial network (NTN). An NTN is a network, or a segment of a network, that includes one or more NTN entities, such as uncrewed aircraft systems (UASs) or satellites, that carry a relay node or a network entity for a wireless communication system in different constellations (e.g., satellite constellations). NTN entities may operate in a low Earth orbit, a medium Earth orbit, a geostationary Earth orbit, or a high elliptical orbit, among other examples.

### SUMMARY

The systems, methods, and devices of this disclosure each have several innovative aspects, no single one of which is solely responsible for the desirable attributes disclosed herein.

Some aspects described herein relate to a first network entity. The first network entity may include a processing system. The processing system may be configured to receive a first message that indicates multiple time division duplex (TDD) patterns that are each associated with one or more first time intervals, wherein the one or more first time intervals are associated with a periodic pattern. The processing system may be configured to communicate a second message in accordance with a TDD pattern of the multiple TDD patterns.

Some aspects described herein relate to a first network entity. The first network entity may include a processing system. The processing system may be configured to transmit a first message that indicates multiple TDD patterns that are each associated with one or more first time intervals, wherein the one or more first time intervals are associated with a periodic pattern. The processing system may be configured to communicate a second message, associated with a second network entity, in accordance with a TDD pattern of the multiple TDD patterns.

Some aspects described herein relate to a method of wireless communication performed by a first network entity. The method may include receiving a first message that indicates multiple TDD patterns that are each associated with one or more first time intervals, wherein the one or more first time intervals are associated with a periodic pattern. The method may include communicating a second message in accordance with a TDD pattern of the multiple TDD patterns.

Some aspects described herein relate to a method of wireless communication performed by a first network entity. The method may include transmitting a first message that indicates multiple TDD patterns that are each associated with one or more first time intervals, wherein the one or more first time intervals are associated with a periodic pattern. The method may include communicating a second message, associated with a second network entity, in accordance with a TDD pattern of the multiple TDD patterns.

Some aspects described herein relate to a non-transitory computer-readable medium having code stored thereon. The code, when executed by a network entity, may cause the network entity to receive a first message that indicates multiple TDD patterns that are each associated with one or more first time intervals, wherein the one or more first time intervals are associated with a periodic pattern. The code, when executed by a network entity, may cause the network entity to communicate a second message in accordance with a TDD pattern of the multiple TDD patterns.

Some aspects described herein relate to a non-transitory computer-readable medium having code stored thereon. The code, when executed by a network entity, may cause the network entity to transmit a first message that indicates multiple TDD patterns that are each associated with one or more first time intervals, wherein the one or more first time intervals are associated with a periodic pattern. The code, when executed by a network entity, may cause the network entity to communicate a second message, associated with a second network entity, in accordance with a TDD pattern of the multiple TDD patterns.

Some aspects described herein relate to an apparatus for wireless communication. The apparatus may include means for receiving a first message that indicates multiple TDD patterns that are each associated with one or more first time intervals, wherein the one or more first time intervals are associated with a periodic pattern. The apparatus may include means for communicating a second message in accordance with a TDD pattern of the multiple TDD patterns.

Some aspects described herein relate to an apparatus for wireless communication. The apparatus may include means for transmitting a first message that indicates multiple TDD patterns that are each associated with one or more first time intervals, wherein the one or more first time intervals are associated with a periodic pattern. The apparatus may include means for communicating a second message, associated with a second network entity, in accordance with a TDD pattern of the multiple TDD patterns.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating an example disaggregated network node architecture.

FIG. 4 is a diagram of an example of a regenerative satellite deployment and an example of a transparent satellite deployment in a non-terrestrial network (NTN).

FIG. 5 is a diagram of an example of an NTN deployment.

FIG. 6 is a diagram of an example of a time division duplex (TDD) configuration.

FIG. 7 is a diagram of an example associated with multiple TDD patterns for a time interval.

FIG. 8 is a diagram of an example associated with multiple TDD patterns for a time interval.

FIG. 9 is a diagram illustrating an example process performed, for example, at a first network entity or an apparatus of a first network entity.

FIG. 10 is a diagram illustrating an example process performed, for example, at a first network entity or an apparatus of a first network entity.

FIG. 11 is a diagram of an example apparatus for wireless communication.

FIG. 12 is a diagram of an example apparatus for wireless communication.

### DETAILED DESCRIPTION

Time division duplexing is a communication technique in a wireless communication network in which transmission and reception operations occur in distinct time intervals on a shared frequency channel. A time division duplex (TDD) system may be associated with alternating between time intervals allocated for uplink communications (e.g., communications from a user equipment (UE) to a network node) and time intervals allocated for downlink communications (e.g., communications from the network node to the UE). The allocation of time intervals may be controlled by a timing schedule that may specify the duration and sequencing of the uplink and downlink time intervals, in accordance with a TDD pattern, which is a sequence of time intervals that may define alternating periods of uplink communications or downlink communications on a shared frequency channel. The TDD pattern may include a series of time intervals, and each time interval may be allocated for either uplink communications or downlink communications. A UE may be configured with one or more repeating TDD patterns. For example, a TDD pattern may include X time intervals that are allocated for downlink communications, for uplink communications, or with a flexible designation (e.g., a time interval configured with a flexible designation may be used for downlink or uplink). After X time intervals, the TDD pattern may repeat. The UE may be configured with a single repeating TDD pattern. Alternatively, the UE may be configured with two alternating TDD patterns.

As used herein, “time interval” refers to a frame (or radio frame), a subframe, a slot, a mini-slot (e.g., one or more symbols), a symbol (e.g., an orthogonal frequency division multiplexing (OFDM) symbol or a symbol period), a transmission time interval (TTI), a scheduling unit, or another time unit. For example, a transmission timeline for each of the downlink and uplink may be partitioned into units of radio frames (sometimes referred to as frames). Each radio frame may have a predetermined duration (e.g., 10 milliseconds) and may be partitioned into a set of Z (Z≥1) subframes. Each subframe may have a predetermined duration (e.g., 1 millisecond) and may include a set of slots (e.g., 2 m slots per subframe, where m is an index of a numerology used for a transmission, such as 0, 1, 2, 3, 4, or another number). Each slot may include a set of L symbol periods. For example, each slot may include fourteen symbol periods, seven symbol periods, or another number of symbol periods. In an example where the subframe includes two slots (e.g., when m=1), the subframe may include 2L symbol periods, where the 2L symbol periods in each subframe may be assigned indices of 0 through 2L−1. In some examples, a scheduling unit may be frame-based, subframe-based, slot-based, mini-slot based, or symbol-based.

In some examples, a wireless communication network may include a non-terrestrial network (NTN) deployment. An NTN may facilitate access to the wireless communication network for remote areas that may not otherwise be within a coverage area of a terrestrial network node, such as over water or remote areas in which a terrestrial network is not deployed. An NTN node may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, or a high elliptical orbit (HEO) satellite, among other examples. A service link (e.g., between an NTN node and a UE) may experience propagation delays due to the large distance between the NTN node and the UE. The propagation delay may be significantly larger than in a terrestrial network because of the increased distance between the NTN node and the UE (e.g., as compared to a typical distance between the UE and a terrestrial network node). For example, a UE may experience propagation delays of 2 milliseconds or larger.

To compensate for the propagation delay, the UE may apply a timing advance (TA) to adjust a timing of an uplink transmission to the NTN node. The UE may apply the TA to ensure that an uplink transmission arrives at the NTN node at a correct time. For example, if a propagation delay experienced by the NTN node is P milliseconds, than the UE may apply a TA that is based on the P milliseconds to account for the propagation delay, such that uplink transmissions arrive at the NTN node at an expected time (e.g., where the expected time is based on a TDD configuration). In some examples, the propagation delay in an NTN may be larger than a duration of a time interval, such as a subframe, that is associated with a TDD pattern. For example, the propagation delay may be 2 milliseconds and a duration of a subframe may be 1 millisecond. Therefore, the UE may adjust a timing of uplink transmissions by one or more full time intervals (e.g., subframes). An NTN node may transmit (e.g., broadcast) a TDD configuration that is applicable for all UEs operating in an NTN cell associated with that NTN node.

A TDD configuration may account for the propagation delay or the TA. For example, because of the TA applied by the UE, an uplink transmission timeline may be shifted in time relative to an uplink transmission timeline at the UE. Therefore, there may be one or more time intervals that are unavailable for use by the UE because the NTN node is either transmitting or receiving during those time intervals. For example, because of the TA or the propagation delay, there may be one or more time intervals that could have otherwise been configured as downlink time intervals that are unavailable for use by the UE because the NTN node is configured to receive uplink communications (e.g., in accordance with the uplink transmission timeline) during those one or more time intervals. Similarly, there may be one or more time intervals that could have otherwise been configured as uplink time intervals that are unavailable for use by the UE because the NTN node is configured to transmit downlink communications (e.g., in accordance with the downlink transmission timeline) during those one or more time intervals.

As a result, a UE operating in accordance with a TDD configuration in an NTN may have inefficient resource utilization because some radio resources (e.g., one or more time intervals) may be unavailable for use by the UE due to the shifted uplink transmission timeline and downlink transmission timeline due to the large propagation delay experienced in the NTN. Additionally, because different UEs operating in the NTN may be associated with different propagation delays at the NTN node (e.g., service links for respective UEs may have different propagation delays), separate TDD configurations for each UE (e.g., to improve the resource utilization for each UE) may increase the risk of collisions at the NTN node. A “collision” may refer to a scenario in which an uplink communication arrives at the NTN node during a time interval configured for downlink (or at a time at which the NTN node is transmitting a downlink communication). Collisions may degrade communication performance for the NTN node, or increase interference, among other examples.

Various aspects relate generally to configuring multiple TDD patterns for a time interval. Some aspects relate to a first network entity transmitting, and a second network entity receiving, a TDD configuration (e.g., that is associated with a set of time intervals configured to repeat over time based on a TDD periodicity), where a subset of one or more time intervals, from the set of time intervals, are configured with multiple TDD patterns. In some aspects, the multiple TDD patterns may indicate different transmission direction allocations (e.g., uplink or downlink) for respective time intervals included in the subset of one or more time intervals. In some aspects, the first network entity may be an NTN node and the second network entity may be a UE. The multiple TDD patterns may be based on one or more TA values or one or more propagation delays. In some examples, the multiple TDD patterns may be configured for network entities (e.g., UEs) within a cell, a coverage area, or associated with a beam of the first network entity, among other examples. The multiple TDD patterns may be based on one or more TA values or one or more propagation delays associated with network entities (e.g., UEs) within the cell, the coverage area, or associated with the beam of the first network entity.

In some aspects, the first network entity and the second network entity may communicate (e.g., transmit or receive) one or more messages in accordance with a TDD pattern of the multiple TDD patterns. In some examples, the first network entity and the second network entity may communicate (e.g., transmit or receive) the one or more messages during the subset of one or more time intervals. In some aspects, the first network entity and the second network entity may determine or select the TDD pattern for the second network entity based on association information that indicates the TDD pattern is associated with the second network entity. The association information may include a rule or a function. For example, the association information may indicate that the TDD pattern is associated with the second network entity based on the association information including an indication that an identifier of the second network entity is associated with the TDD pattern. The identifier may be a radio network temporary identifier (RNTI). In some aspects, the message that includes the TDD configuration may include the association information.

Particular aspects of the subject matter described in this disclosure can be implemented to realize one or more of the following potential advantages. In some examples, the described techniques can be used to improve resource utilization efficiency for wireless communication networks that use a TDD configuration. For example, the described techniques can be used to improve resource utilization efficiency for an NTN that uses a TDD configuration. For example, by the first network entity configuring the multiple TDD patterns, a quantity of time intervals for a TDD configuration or pattern that are unavailable for use by the first network entity may be reduced. For example, at a given time, the multiple TDD patterns may indicate that different network entities (e.g., different UEs) are to apply different transmission directions (e.g., uplink or downlink). In this case, a TDD pattern determined by the first network entity (e.g., an NTN node) ensures a collision (e.g. simultaneous transmission and reception) will not happen at the UE applying the considered TDD pattern. Since at least a subset of the one or more time intervals, from the set of time intervals indicated in the TDD pattern, are configured with multiple TDD patterns, different UEs with the different TDD patterns may be configured with different communication directions for a considered time interval. As a result, the different network entities (e.g., different UEs) may be able to communicate (e.g., transmit or receive) during time intervals that would have otherwise been unavailable for use by the NTN node. Additionally, by the first network entity configuring the multiple TDD patterns for network entities within a given cell, a given coverage area, or for a given beam, the first network entity can account for varying TA values or propagation delays experienced by the network entities (e.g., because network entities within a given cell, a given coverage area, or for a given beam may apply relatively similar TA values).

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

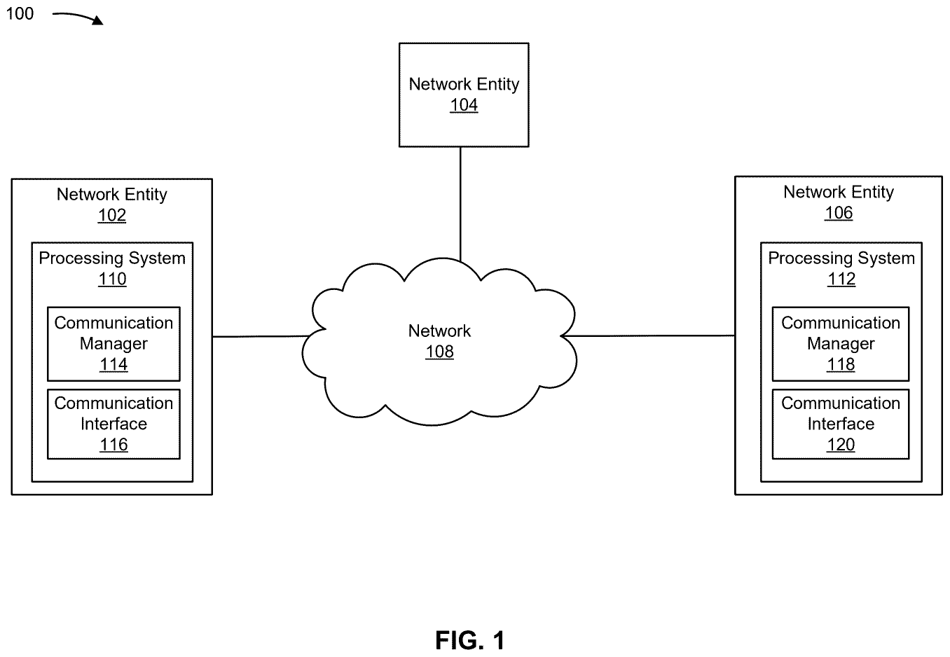

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

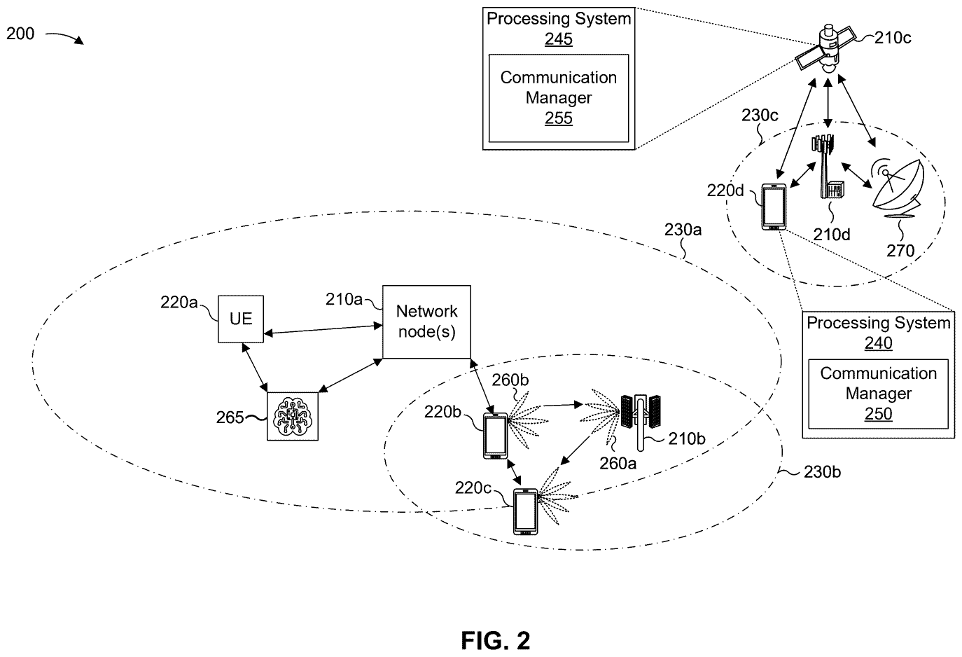

The network 108 may include, for example, a cellular network (e.g., a Long-Term Evolution (LTE) network, a CDMA network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive a first message that indicates multiple TDD patterns that are each associated with one or more first time intervals, wherein the one or more first time intervals are associated with a periodic pattern; and communicate a second message in accordance with a TDD pattern of the multiple TDD patterns. Additionally, or alternatively, the network entity 102 or the communication manager 114 may perform one or more other operations described herein.

As described in more detail elsewhere herein, the network entity 106 may (e.g., the processing system 112 may, or the processing system 112 may cause the communication manager 118 or the communication interface 120 to) transmit a first message that indicates multiple TDD patterns that are each associated with one or more first time intervals, wherein the one or more first time intervals are associated with a periodic pattern; and communicate a second message, associated with a second network entity, in accordance with a TDD pattern of the multiple TDD patterns. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a, a network node 210b, a network node 210c, and a network node 210d (each of which also may be referred to herein simply as a “network node 210”). The network nodes 210 may support communications with multiple UEs 220. For example, in FIG. 2, the network nodes 210 support communication with a UE 220a, a UE 220b, a UE 220c, and a UE 220d (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

As indicated above, a network node 210 may be a terrestrial network node 210 (for example, a terrestrial base station or entity of a disaggregated base station) or an NTN network node 210. In the example shown in FIG. 2, the network node 210c may be an NTN node (for example, a network node 210 configured to operate in an NTN) and the cell 230c may be an NTN cell. For example, the wireless communication network 200 may include one or more NTN deployments including an NTN node or a relay station. In some examples, a relay station in an NTN deployment may be referred to as a “non-terrestrial relay station.” An NTN may facilitate access to the wireless communication network 200 for remote areas that may not otherwise be within a coverage area of a terrestrial network node 210, such as over water or remote areas in which a terrestrial network is not deployed. An NTN may provide connectivity for various applications, including satellite communications, IoT, MTC, or other applications. An NTN node (such as the network node 210c) may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, or a high elliptical orbit (HEO) satellite, among other examples. A manned aircraft system may include an airplane, a helicopter, or a dirigible, among other examples. A UAS platform may include a high-altitude platform station (HAPS), a balloon, a dirigible, or an airplane, among other examples.

An NTN node may communicate directly or indirectly with other entities in the wireless communication network 200 using NTN communication. The other entities may include UEs 220 (for example, the UE 220d), other NTN network nodes 210 in the one or more NTN deployments, other types of network nodes 210 (for example, stationary, terrestrial, or ground-based network nodes, such as the network node 210d), relay stations, or one or more components or devices included in or coupled with a core network of the wireless communication network 200. For example, an NTN node may communicate with a UE 220 via a service link (for example, where the service link includes an access link). Additionally or alternatively, an NTN node may communicate with a gateway 270 (for example, a terrestrial node providing connectivity for the NTN node to a data network or a core network) via a feeder link (for example, where the feeder link is associated with an N2 or an N3 interface). Additionally, or alternatively, NTN nodes may communicate directly with one another via an inter-satellite link (ISL). In some examples, an NTN deployment may be transparent (for example, where the NTN node operates in a similar manner as a repeater or relay or where an access link does not terminate at the NTN node). In some other examples, an NTN deployment may be regenerative. For example, an access link may terminate at the NTN node, and the NTN node may regenerate a signal (such as by performing signal processing or enhancement, which may include error correction, modulation or demodulation, or amplification).

In some examples, NTNs may support advanced technologies or capabilities, such as global narrowband Internet of things (IoT) or massive machine type communication (mMTC) coverage (for example, NTNs may provide continuous coverage for narrowband IoT devices or mMTC devices to transfer data to a central entity), enhanced tracking (for example, NTNs may enable improved tracking for a moving platform (for example, a ship, a train, a plane, or a truck) carrying specific items to be tracked), emergency or disaster management, ultra mobile broadband (ultra-mBB) (for example, NTNs may enable a UE 220 to receive or transmit large amounts of data with improve quality of experience over a wider geographic area), immersive communications (for example, NTNs may support holographic communications, or extended reality (XR) communications, among other examples, to enable fully immersive user experiences), ultra-massive communications (for example, NTNs may enable tracking, monitoring, control, or environment sensing for IoT devices or mMTC devices, enabling applications, such as smart cities, smart agriculture, smart transportation, or smart logistics) ultra-critical communications (for example, NTNs may support services with increased requirements for latency, availability, or reliability. This enables applications, such as tactile or haptic Internet, remote surgery, or remote industrial management) network sensing (for example, NTNs may support RF sensing or an integrated sensing and communication (ISAC) service), or integrated artificial intelligence (AI) (for example, NTNs may support distributed or integrated AI applications), among other examples. In some examples, NTNs may provide connectivity for one or more verticals, such as aeronautical platforms, maritime platforms, railways, automotive platforms, rural areas, government platforms, or emergency services, among other examples.

An NTN may provide direct connectivity to the wireless communication network 200 for one or more UEs 220, such as the UE 220d. In some examples, a UE 220 may be configured to access the wireless communication network 200 via a terrestrial network (for example, the cell 230a) or an NTN (for example, the cell 230c) using common hardware or software (for example, using common radios or antennas). NTNs may provide ubiquitous connectivity for UEs 220 through compatibility with terrestrial networks (for example, NTNs and terrestrial networks may use compatible waveforms (for example, waveforms supported by both an NTN and a terrestrial network) for seamless handovers between NTNs and terrestrial networks, or UEs may use common hardware or software for communicating via NTNs and terrestrial networks), spectrum sharing (for example, a flexible waveform design may enable spectrum sharing between NTNs and terrestrial networks), robustness to co-channel interference, network-based positioning (for example, dedicated pilot signals or reference signals may be used to facilitate accurate timing and phase measurements for accurate positioning), support of UEs without location resolution data (for example, for UEs without access to a global navigation satellite system (GNSS)), or support of TDD and frequency division duplex (FDD) systems, among other examples.

In some aspects, a network entity, shown as the UE 220d in FIG. 2 as an example, may include a communication manager 250. As described in more detail elsewhere herein, the communication manager 250 may receive a first message that indicates multiple TDD patterns that are each associated with one or more first time intervals, wherein the one or more first time intervals are associated with a periodic pattern; and communicate a second message in accordance with a TDD pattern of the multiple TDD patterns. Additionally, or alternatively, the communication manager 250 may perform one or more other operations described herein.

In some aspects, a network entity, shown as the network node 210c in FIG. 2 as an example, may include a communication manager 255. As described in more detail elsewhere herein, the communication manager 255 may transmit a first message that indicates multiple TDD patterns that are each associated with one or more first time intervals, wherein the one or more first time intervals are associated with a periodic pattern; and communicate a second message, associated with a second network entity, in accordance with a TDD pattern of the multiple TDD patterns. Additionally, or alternatively, the communication manager 255 may perform one or more other operations described herein.

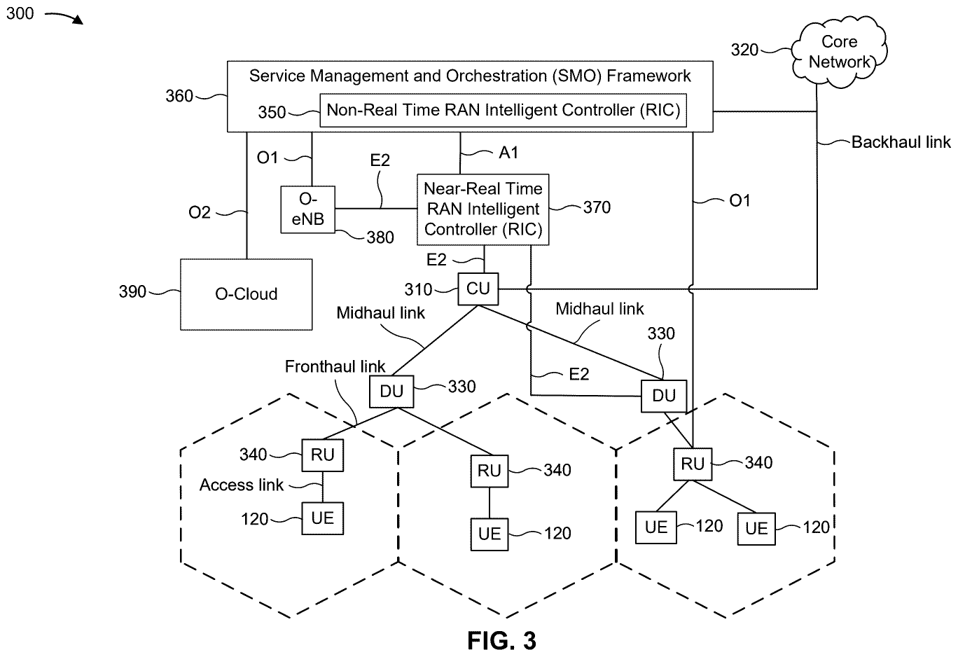

FIG. 3 is a diagram illustrating an example disaggregated network node architecture 300. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, or a Near-RT RIC 370. In some aspects, the SMO Framework 360 may communicate with a hardware aspect of a 4G RAN, a 5G NR RAN, or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, or policy-based guidance of applications or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

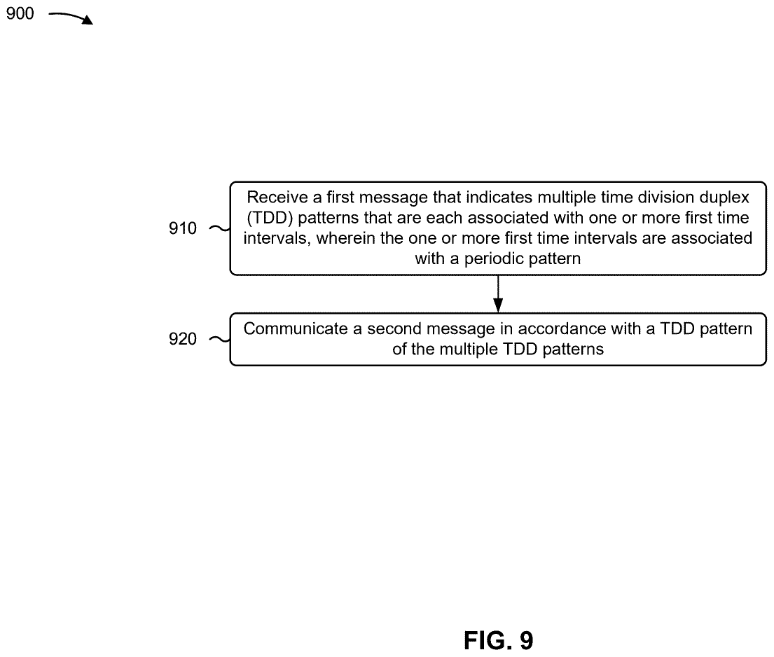

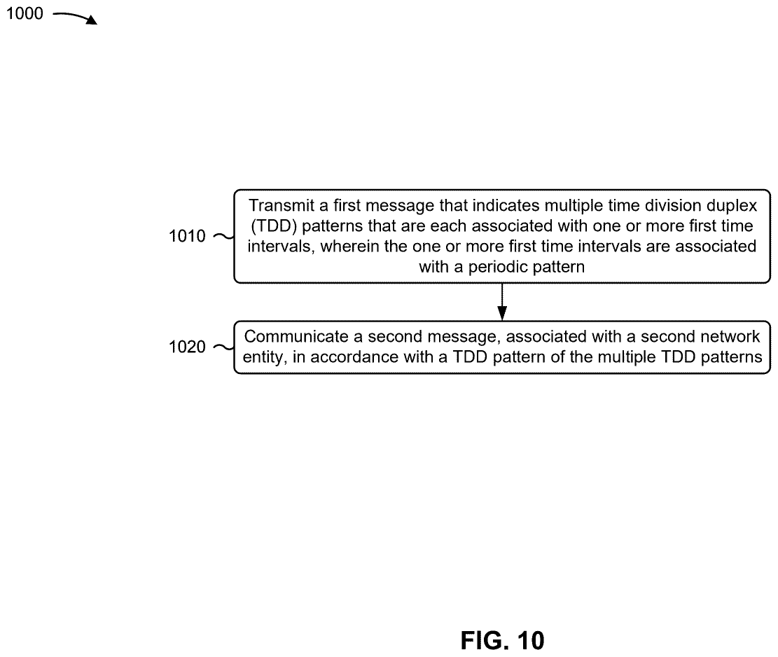

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with multiple TDD patterns for a time interval, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 900 of FIG. 9, process 1000 of FIG. 10, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

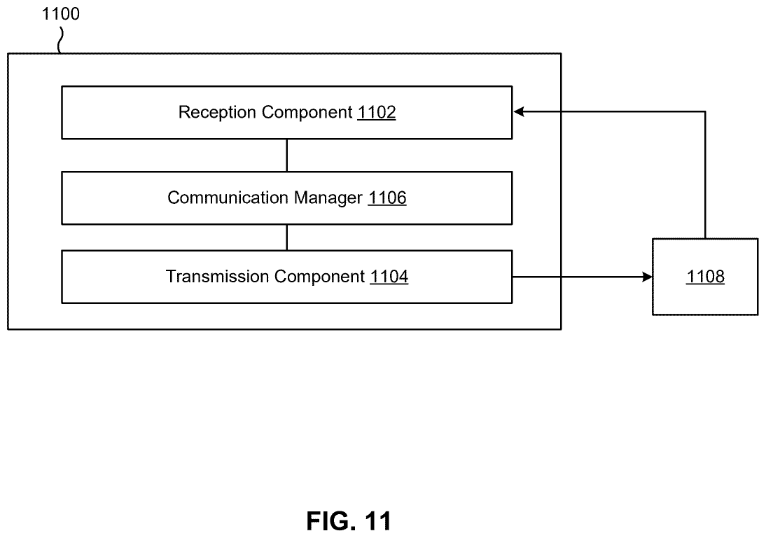

In some aspects, a network entity includes means for receiving a first message that indicates multiple TDD patterns that are each associated with one or more first time intervals, wherein the one or more first time intervals are associated with a periodic pattern; or means for communicating a second message in accordance with a TDD pattern of the multiple TDD patterns. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1102 depicted and described in connection with FIG. 11) or a transmission component (for example, transmission component 1104 depicted and described in connection with FIG. 11), among other examples.

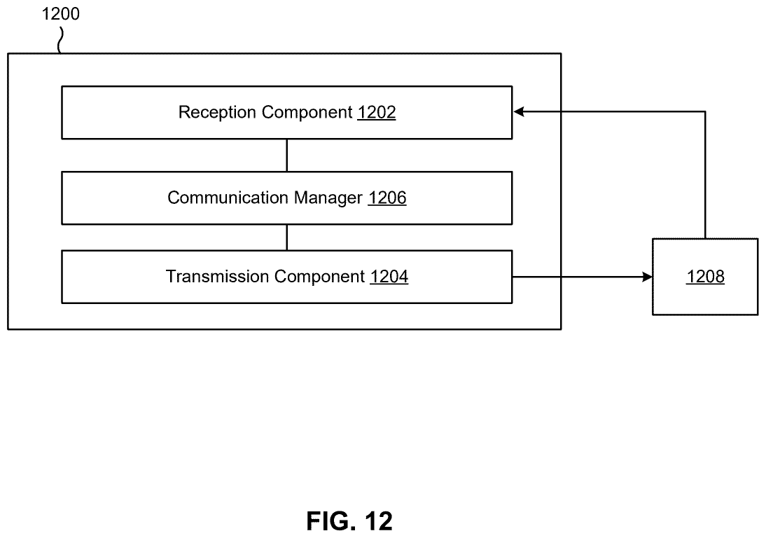

In some aspects, the network entity includes means for transmitting a first message that indicates multiple TDD patterns that are each associated with one or more first time intervals, wherein the one or more first time intervals are associated with a periodic pattern; or means for communicating a second message, associated with a second network entity, in accordance with a TDD pattern of the multiple TDD patterns. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

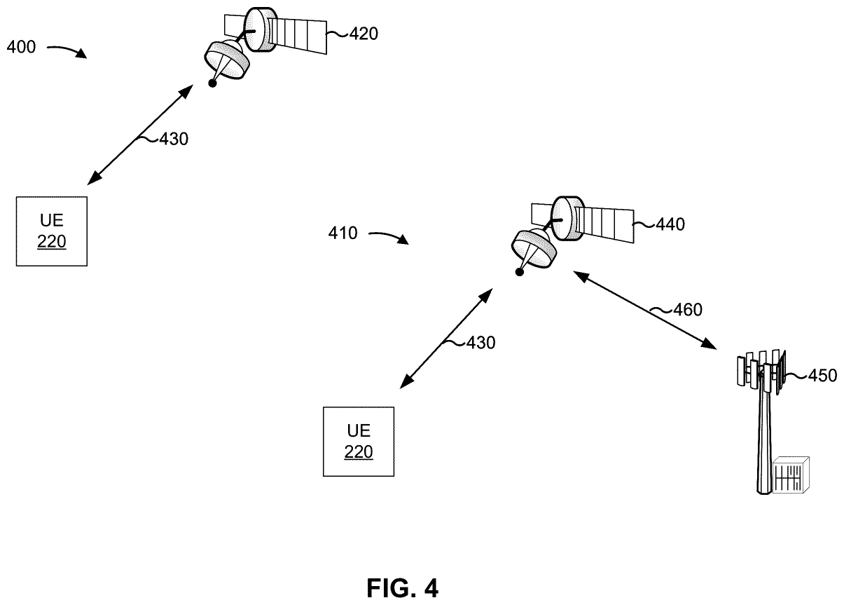

FIG. 4 is a diagram of an example 400 of a regenerative satellite deployment and an example 410 of a transparent satellite deployment in a non-terrestrial network.

Example 400 shows a regenerative satellite deployment. In example 400, a UE 220 is served by a satellite 420 via a service link 430. For example, the satellite 420 may include a network node 210 (e.g., network node 210c) or a gNB. In some aspects, the satellite 420 may be referred to as an NTN node, an NTN entity, a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 220, such as the cell 230c. In some examples, the example 400 may include a gateway (not shown in FIG. 4). The satellite 420 and the gateway may communicate via a feeder link. The gateway may support one or more network functions associated with interfacing between an NTN and a terrestrial network. In the example 400, the satellite 420 may support or perform functions associated with a network node 210 or gNB and the gateway may support or perform one or more other network functions.

Example 410 shows a transparent satellite deployment, which may also be referred to as a bent-pipe satellite deployment. In example 410, a UE 220 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify or filter the uplink radio frequency transmission. In some aspects, the UEs 120 shown in example 400 and example 410 may be associated with a GNSS capability or a GPS capability, though not all UEs have such capabilities. The satellite 440 may provide a cell that covers the UE 220, such as the cell 230c.

The service link 430 may include a link between the satellite 440 and the UE 220, and may include one or more of an uplink or a downlink. The feeder link 460 may include a link between the satellite 440 and the gateway 450, and may include one or more of an uplink (e.g., from the UE 220 to the gateway 450) or a downlink (e.g., from the gateway 450 to the UE 220). The feeder link 460 and the service link 430 may each experience propagation delays due to the distance between the satellite 420 or the satellite 440, and a UE 220 or the gateway 450. These propagation delays may be significantly larger than in a terrestrial network

As indicated above, FIG. 4 is provided as an example. Other examples may differ from what is described with regard to FIG. 4.

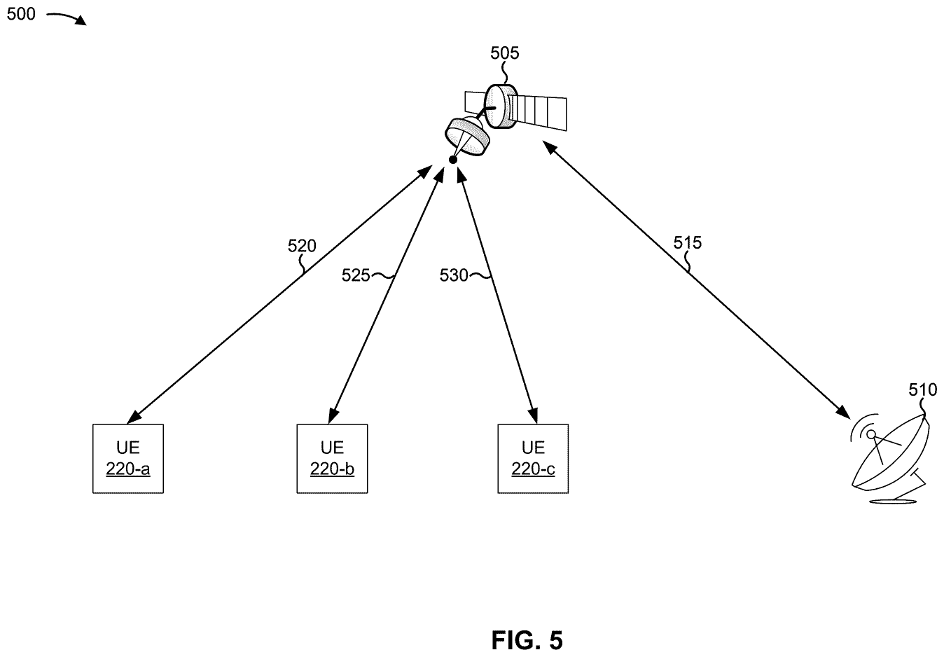

FIG. 5 is a diagram of an example 500 of an NTN deployment. As shown in FIG. 5, the NTN deployment may include an NTN node 505, one or more UEs 220 (shown as UE 220-a, UE 220-b, and UE 220-c), and a gateway 510. The NTN node 505 may be, or may be similar to, the network node 210c, the satellite 420, or the satellite 440. The gateway 510 may be similar to the gateway 450. The NTN node 505 may communicate with the gateway 510 via a feeder link 515. The feeder link 515 may be similar to the feeder link 460.

The NTN node 505 may communicate with the one or more UEs via respective service links, such as a service link 520 (e.g., between the NTN node 505 and the UE 220-a), a service link 525 (e.g., between the NTN node 505 and the UE 220-b), and a service link 530 (e.g., between the NTN node 505 and the UE 220-c). For example, the service link 520 may be associated with a first beam of the NTN node 505. The second service link 525 may be associated with a second beam of the NTN node 505. The third service link 530 may be associated with a third beam of the NTN node 505.

In some examples, the different service links may be associated with different propagation delays due to differences in distances between the one or more UEs and the NTN node 505. For example, the service link 520 may be associated with a first propagation delay. The service link 525 may be associated with a second propagation delay. The service link 530 may be associated with a third propagation delay. As an example, the NTN node 505 may be configured to operate at an altitude of 600 kilometers with a 25 degree minimal elevation angle. In such examples, the first propagation delay may be 2 milliseconds, the second propagation delay may be 3 milliseconds, and the third propagation delay may be 4 milliseconds.

In some examples, the NTN node 505 may operate using a frequency band that is configured for FDD operation. In some other examples, the NTN node 505 may operate using a frequency band that is configured for TDD operation. For example, one or more frequency bands that are configured or designation for TDD operation for terrestrial networks may be reused for TDD operation in an NTN network. For example, some frequency bands configured or designation for TDD operation for terrestrial networks are expected to be used in deployments in relatively densely populated areas. Such frequency bands may be used by an NTN network for TDD operation in less populated areas, thereby improving resource utilization efficiency. For example, integrated terrestrial network and NTN may include one or more frequency bands configured for frequency utilization for both terrestrial networks and NTN, to better support complementary coverage. However, due to the large propagation delays experienced in NTNs, TDD operation may be difficult.

As indicated above, FIG. 5 is provided as an example. Other examples may differ from what is described with regard to FIG. 5.

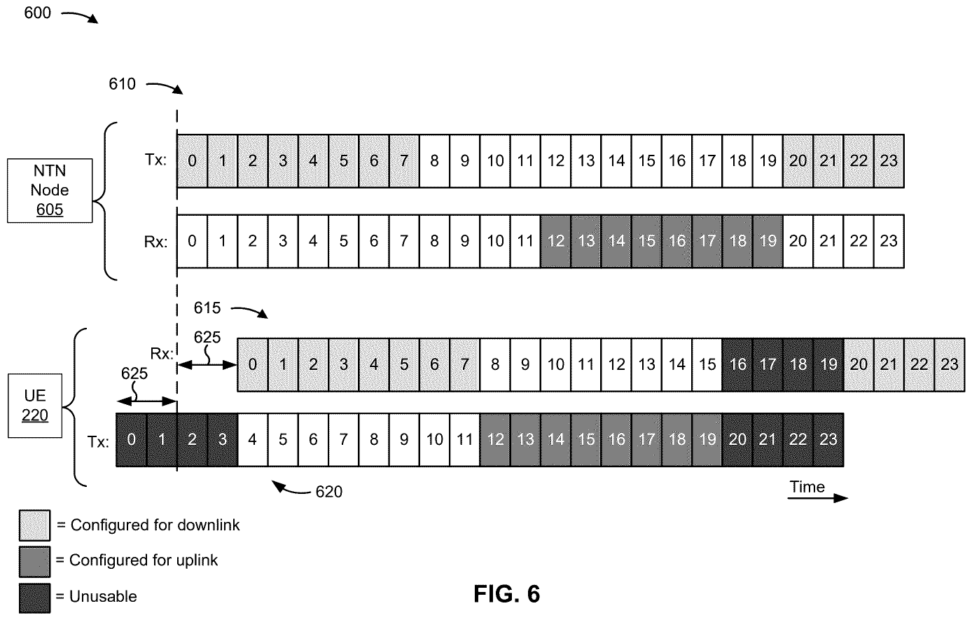

FIG. 6 is a diagram of an example 600 of a TDD configuration. As shown in FIG. 6, a TDD configuration 610 for an NTN node 605 may indicate a TDD pattern for a set of time intervals (shown in FIG. 6 as time interval 0 through time interval 23). The NTN node 605 may be, or may be similar to, the NTN node 505, the network node 210c, the satellite 420, or the satellite 440. The NTN node 505 may transmit (e.g., broadcast, such as in system information) configuration information that indicates the TDD configuration 610. A UE 220 may receive and apply the TDD configuration 610 for a downlink transmission timeline 615 and an uplink transmission timeline 620.

The TDD pattern may indicate an allocation of a transmission direction for some of the time intervals. For example, the time interval 0 through the time interval 7 may be configured for downlink communication. The time interval 12 through the time interval 19 may be configured for uplink communication. The time interval 20 through the time interval 23 may be configured downlink communication.

As shown in FIG. 6, the downlink transmission timeline 615 and the uplink transmission timeline 620 at the UE 220 may be shifted in time relative to each other. For example, the UE 220 may apply a TA value 625 to uplink communications, resulting in a shift in the uplink transmission timeline 620 (e.g., shifting the uplink transmission timeline 620 backward in time relative to a synchronization point). Additionally, because of a propagation delay between the NTN node 605 and the UE 220, the downlink transmission timeline 615 may be shifted (e.g., forward in time relative to the synchronization point) due to the propagation delay of downlink communications transmitted by the NTN node 605. Due to the shifts of the downlink transmission timeline 615 and the uplink transmission timeline 620 at the UE 220, one or more time intervals may be unavailable for use at the UE 220. For example, even though the time intervals 0 through 3 in the uplink transmission timeline 620 do not overlap in time with the time intervals 0 through 3 in the downlink transmission timeline 615, the time intervals 0 through 3 may be unavailable for uplink use for the UE 220 because the NTN node 605 may be transmitting downlink communications during the time intervals 0 through 3.

As another example, the time interval 16 through the time interval 19 in the downlink transmission timeline 615 may be unavailable for use at the UE 220. For example, the time interval 16 through the time interval 19 may otherwise be available for downlink communication at the UE 220 (e.g., because they do not overlap in time with time intervals configured for uplink communication in the uplink transmission timeline 620). However, the NTN node 605 may be configured to receive uplink communications during the time interval 16 through the time interval 19. Therefore, the time interval 16 through the time interval 19 may be unavailable for use for downlink communication at the UE 220. Similarly, the UE 220 may be unable to use the time interval 20 through the time interval 23 in the uplink transmission timeline 620 because the time interval 20 through the time interval 23 are configured for downlink communication at the NTN node 605 based on the TDD configuration 610.

As another example, the TDD configuration 610 may not allocate time interval 8 through time interval 11 for communication because this would result in the UE 220 being configured to transmit and receive communications at the same time. For example, time interval 8 through time interval 11 in the downlink transmission timeline 615 overlap in the time domain with time interval 12 through time interval 15 in the uplink transmission timeline 620 (e.g., which are configured for uplink communication). Similarly, time interval 8 through time interval 11 in the uplink transmission timeline 620 overlap in the time domain with time interval 4 through time interval 7 in the downlink transmission timeline 615 (e.g., which are configured for downlink communication). Therefore, the NTN node 605 may be unable to use the time interval 8 through time interval 11 for communication.

As a result, the UE 220 operating in accordance with the TDD configuration 610 in an NTN may have inefficient resource utilization because some radio resources (e.g., one or more time intervals) may be unavailable for use by the UE 220 due to the shifted uplink transmission timeline 620 and downlink transmission timeline 615 due to the large propagation delay experienced in the NTN. Additionally, because different UEs operating in the NTN may be associated with different propagation delays at the NTN node (e.g., service links for respective UEs may have different propagation delays), separate TDD configurations for each UE (e.g., to improve the resource utilization for each UE) may increase the risk of collisions at the NTN node.

As indicated above, FIG. 6 is provided as an example. Other examples may differ from what is described with regard to FIG. 6.

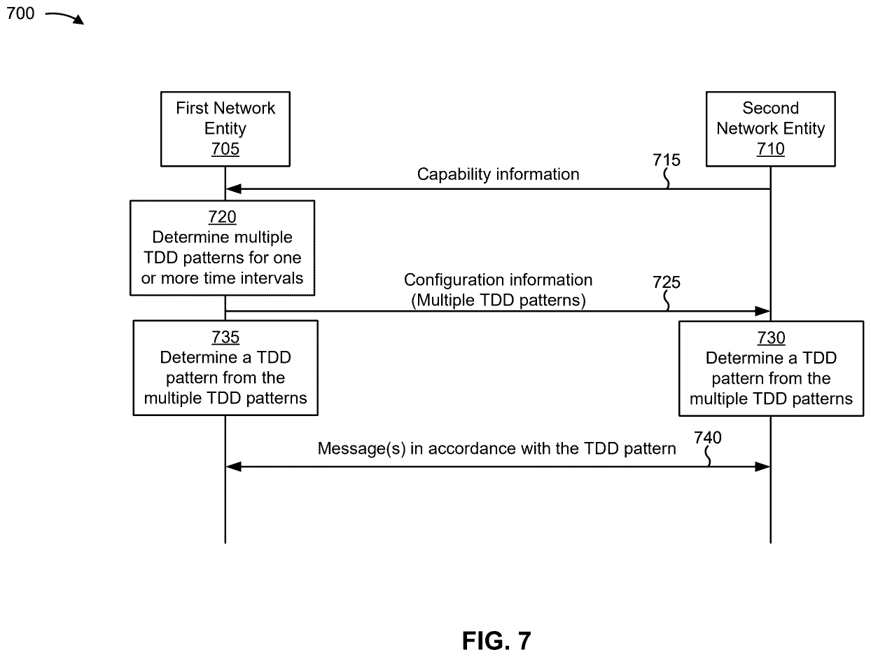

FIG. 7 is a diagram of an example 700 associated with multiple TDD patterns for a time interval. As shown in FIG. 7, a first network entity 705 (e.g., the network entity 102, the network entity 106, a network node 210, the satellite 420, the satellite 440, the NTN node 505, or the NTN node 605) may communicate with a second network entity (e.g., the network entity 102, the network entity 106, or the UE 220). In some aspects, the first network entity 705 and the second network entity 710 may be part of a wireless network (e.g., the wireless communication network 200). In some examples, the first network entity 705 and the second network entity 710 may have established a wireless connection prior to operations shown in FIG. 7.

Some examples are described herein using an NTN as an example wireless communication network in which the multiple TDD patterns may be applicable. However, a TDD configuration that includes multiple TDD patterns that are each applicable to one or more time intervals (e.g., where the multiple TDD patterns are applicable to the same one or more time intervals) may be similarly be applied for other types of wireless communication networks, such as a terrestrial network.

In some aspects, as shown by reference number 715, the second network entity 710 may transmit capability information. The capability information may be included in a capability report. The second network entity 710 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the second network entity 710. The one or more parameters may be indicated via respective information elements (IEs) included in a capability report.

The capability information may indicate whether the second network entity 710 supports a feature or one or more parameters related to the feature. For example, the capability information may indicate a capability or parameter for supporting TDD, such as for NTN. For example, the capability information may indicate that the second network entity 710 supports communicating using one or more frequency bands configured for, or designated for, TDD operation in an NTN. As another example, the capability information may indicate a capability or parameter for being configured with multiple TDD patterns for one or more time intervals within a TDD configuration. One or more operations described herein may be based on capability information. For example, the second network entity 710 may perform a communication in accordance with the capability information, or may receive configuration information that is in accordance with the capability information.

As shown by reference number 720, the first network entity 705 may determine multiple TDD patterns (or multiple TDD configurations) for one or more time intervals. For example, a TDD configuration may be associated with a set of time intervals that are configured to repeat periodically over time. For example, the set of time intervals may be associated with indexes 0 through 29. The first network entity 705 may determine multiple TDD patterns that are each applicable to a subset of one or more time intervals from the set of time intervals. As an example, the time intervals with indexes 6 through 9 may be associated with multiple TDD patterns (or multiple TDD configurations). Other time intervals, from the set of time intervals, may be associated with a common (or single) TDD pattern. For example, the time intervals with indexes 0 through 5 and 10 through 29 may be associated with a common (or single) TDD pattern.

For example, different network entities (such as the second network entity 710) may communicate with the first network entity 705 during the one or more time intervals (e.g., the subset of one or more time intervals) using different TDD patterns (or different TDD configurations) from the multiple TDD patterns. The first network entity 705 may determine the multiple TDD patterns based on, or otherwise associated with, propagation delays experienced by the first network entity 705, such as for service links and/or feeder links associated with respective network entities. For example, the first network entity 705 may determine multiple TDD patterns for a given coverage area, a given cell, or a given beam, among other examples, of the first network entity 705. The first network entity 705 may determine the multiple TDD patterns (e.g., for a given coverage area, a given cell, or a given beam) based on one or more transmission delays (e.g., one or more propagation delays (or a range of propagation delays) or one or more TA values (or a range of TA values)) associated with network entities operating in association with the given coverage area, the given cell, or the given beam. For example, the first network entity 705 may determine the multiple TDD patterns to mitigate or avoid collisions at the first network entity 705 based on the one or more propagation delays (or a range of propagation delays) or one or more TA values (or a range of TA values).

As shown by reference number 725, the first network entity 705 may transmit, and the second network entity 710 may receive, configuration information. In some aspects, the second network entity 710 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more RRC messages, one or more MAC CEs or one or more DCI messages, among other examples.

In some aspects, the configuration information may include an indication of a selection of one or more configuration parameters (e.g., a selection of the one or more configuration parameters already known to the second network entity 710 or previously indicated by the network node or other network device), or explicit configuration information for the second network entity 710 to use to configure the second network entity 710, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that a TDD configuration. The TDD configuration may indicate a transmission direction applicable to respective time intervals included in a set of time intervals (e.g., a set of subframes, slots, symbols, or another time interval). The set of time intervals may be configured to repeat periodically over time. For example, the set of time intervals may be associated with a periodic pattern. The TDD configuration may indicate that a subset of one or more time intervals, from the set of time intervals, are associated with multiple TDD patterns (or multiple TDD configurations). For example, the TDD configuration may indicate that multiple TDD patterns are each applicable to the are associated with a periodic pattern.

As an example, the subset of one or more time intervals may include a first time interval, a second time interval, a third time interval, and a fourth time interval. A first TDD pattern, from the multiple TDD patterns, may indicate that the first time interval and the second time interval are configured for uplink communication and the third time interval and the fourth time interval are configured for downlink communication. A second TDD pattern, from the multiple TDD patterns, may indicate that the first time interval and the second time interval are configured for downlink communication and the third time interval and the fourth time interval are configured for uplink communication. A third TDD pattern, from the multiple TDD patterns, may indicate that the first time interval is configured for downlink communication and the second time interval, the third time interval, and the fourth time interval are configured for uplink communication.

The remaining time intervals from the set of time intervals (e.g., that are not included in the subset of one or more time intervals) may be associated with a common TDD pattern. For example, the common TDD pattern may be a single TDD pattern that is applicable for all network entities that receive the TDD configuration or that communicate with the first network entity 705. For example, the remaining time intervals from the set of time intervals may be associated with a single transmission direction (e.g., uplink or downlink) as indicated by the common TDD pattern.

The first network entity 705 may transmit the TDD configuration via a broadcast message. For example, the first network entity 705 may transmit the TDD configuration via a system information message. In some examples, the TDD configuration may be included in a SIB, such as a SIB Type 1 (sometimes referred to as “SIB1”). For example, the system information message may include an IE for indicating a configuration of a serving cell, such as a ServingCellConfigCommonSIB IE. The TDD configuration may be included in the IE (e.g., in the ServingCellConfigCommonSIB IE). For example, the system information message may include an IE or one or more fields for indicating the TDD configuration or the multiple TDD patterns, such as a tdd-UL-DL-ConfigurationCommon IE. By the first network entity 705 indicating the multiple TDD patterns in a system information message, the first network entity 705 may conserve network resources, or power resources, among other examples, that would have otherwise been associated with transmitting dedicated signaling (such as RRC signaling) for each network entity (e.g. each UE) to be configured with which TDD pattern, from the multiple TDD patterns, is to be applied by that network entity.

In some aspects, the system information message may include one or more first IEs for indicating respective TDD patterns of the multiple TDD patterns for the subset of one or more time intervals. The system information message may include an IE for indicating the common TDD pattern that is applicable to remaining time intervals from the set of time intervals. For example, the system information message may include a first IE for indicating a first TDD pattern applicable to the subset of one or more time intervals, a second IE for indicating a second TDD pattern applicable to the subset of one or more time intervals, and a third IE for indicating the common TDD pattern.

As another example, a first message (e.g., a first system information message) may indicate the multiple TDD patterns for the one or more time intervals (e.g., for the subset of one or more time intervals). A second message (e.g., a second system information message) may indicate the common TDD pattern for the remaining time intervals from the set of time intervals. This may enable network entities that are unable to determine which TDD pattern, from the multiple TDD patterns, is to be applied (e.g., network entities that do not have a valid identifier assigned, as described in more detail elsewhere herein) to refrain from, or skip, receiving or decoding the first message, thereby conserving processing resources, or power resources, among other examples, of those network entities. For example, network entities operating in an RRC idle mode or an RRC inactive mode may refrain from, or skip, receiving or decoding the first message, thereby conserving processing resources or power resources of those network entities.

In some aspects, the TDD configuration may indicate the one or more time intervals (e.g., the subset of one or more time intervals) that are associated with the multiple TDD patterns. For example, the TDD configuration may include an indication of the subset of one or more time intervals, from the set of time intervals, for which the multiple TDD patterns are applicable. As another example, the common TDD pattern may indicate that one or more time intervals are configured with a flexible designation. In such examples, the subset of one or more time intervals, from the set of time intervals, for which the multiple TDD patterns are applicable may be the one or more time intervals are configured with a flexible designation.

In some examples, the configuration information (e.g., the TDD configuration) may indicate association information (or associated information) to be used by network entities (e.g., the second network entity 710) to determine which TDD pattern, from the multiple TDD patterns, to apply during the one or more time intervals (e.g., during the subset of one or more time intervals). In other examples, the association information may be defined, or otherwise fixed, by a wireless communication standard, such as the 3GPP (e.g., and not signaled between the first network entity 705 and the second network entity 710).

The association information may include, or indicate, a rule or function to be used to determine which TDD pattern, from the multiple TDD patterns, to apply during the one or more time intervals (e.g., during the subset of one or more time intervals). The association information may indicate that the second network entity 710 is to determine a TDD pattern, from the multiple TDD patterns, based on an identifier of the second network entity 710. For example, the rule or function indicated by the association information may be an identifier-based rule or function. The identifier may be a radio network temporary identifier (RNTI), such as a cell-RNTI (C-RNTI). For example, the rule or function may indicate a mapping or association between identifiers and TDD patterns from the multiple TDD patterns. As an example, the rule or function may indicate that even identifiers (e.g., even C-RNTIs) are to be associated with a first TDD pattern from the multiple TDD patterns, and odd identifiers (e.g., odd C-RNTIs) are to be associated with a second TDD pattern from the multiple TDD patterns (e.g., in an example where the multiple TDD patterns include two TDD patterns).

In some examples, the second network entity 710 may not have been assigned an identifier to be used to determine which TDD pattern, from the multiple TDD patterns, to apply during the one or more time intervals. For example, the second network entity 710 may not have a valid identifier and may be unable to determine which TDD pattern, from the multiple TDD patterns, to apply during the one or more time intervals. For example, if the second network entity 710 is operating in an RRC idle mode or an RRC inactive mode, the second network entity 710 may not have been assigned a valid C-RNTI. In such examples, the second network entity 710 may skip (e.g., may refrain from) communication during the one or more time intervals (e.g., during the subset of one or more time intervals). For example, if the second network entity 710 does not have a valid identifier to be used to determine which TDD pattern to apply, then the second network entity 710 may only communicate during time intervals associated with the common TDD pattern.

As another example, if the second network entity 710 does not have a valid identifier to be used to determine which TDD pattern to apply, then the second network entity 710 may apply a default TDD pattern for the one or more time intervals (e.g., for the subset of one or more time intervals). In some aspects, the configuration information (e.g., the TDD configuration) may indicate the default TDD pattern. In some other aspects, the default TDD pattern may be defined, or otherwise fixed, by a wireless communication standard, such as the 3GPP.

The second network entity 710 may configure itself based at least in part on the configuration information. In some aspects, the second network entity 710 may be configured to perform one or more operations described herein based at least in part on the configuration information.

As shown by reference number 730, the second network entity 710 may determine a TDD pattern, from the multiple TDD patterns, to be applied during the one or more time intervals. For example, the second network entity 710 may apply the determined TDD pattern during the one or more time intervals. As described elsewhere herein, the set of time intervals (e.g., including the one or more time intervals where the determined TDD pattern is applied) may repeat over time periodically. Therefore, each time the one or more time intervals occur (e.g., in accordance with the periodic pattern indicated by the TDD configuration), the second network entity 710 may apply the determined TDD pattern from the multiple TDD patterns.

As shown by reference number 735, the first network entity 705 may determine the TDD pattern, from the multiple TDD patterns, to be applied during the one or more time intervals for the second network entity 710. For example, the first network entity 705 may determine the TDD pattern to be applied by the second network entity 710. The first network entity 705 may determine the TDD pattern in a similar manner as the second network entity 710 determines the TDD pattern, as described herein.

The second network entity 710 may determine the TDD pattern, from the multiple TDD patterns, based on the association information. For example, the second network entity 710 may determine the TDD pattern, from the multiple TDD patterns, based on a rule or a function indicated by the association information. For example, the association information may indicate that a TDD pattern is associated with the second network entity 710 based on the association information including an indication that an identifier (e.g., a C-RNTI) of the second network entity 710 is associated with the TDD pattern. For example, the association information may indicate an association between one or more identifiers and respective TDD patterns of the multiple TDD patterns.

For example, a rule may indicate that sets of one or more identifiers are associated with respective TDD patterns of the multiple TDD patterns. An identifier of the second network entity 710 is included in a set of one or more identifiers from the sets of one or more identifiers. The rule may indicate that the set of identifiers is associated with the TDD pattern. For example, the association information may indicate that even identifiers (e.g., even C-RNTIs) are associated with a first TDD pattern from the multiple TDD patterns. The association information may indicate that odd identifiers (e.g., odd C-RNTIs) are associated with a second TDD pattern from the multiple TDD patterns. The second network entity 710 may determine whether an identifier assigned to the second network entity 710 is an even value or an odd value. The second network entity 710 may determine a TDD pattern, from the first TDD pattern and the second TDD pattern, based on whether an identifier assigned to the second network entity 710 is an even value or an odd value.

As described above, in some cases, the second network entity 710 may not be associated with an identifier that is mapped to, or otherwise associated with, a TDD pattern from the multiple TDD patterns. For example, the second network entity 710 may not have a valid identifier currently assigned to the second network entity 710, such as when the second network entity 710 is operating in an RRC idle mode or an RRC inactive mode. In such examples, the second network entity 710 may determine that the one or more time intervals (e.g., the subset of one or more time intervals) are unavailable for use by the second network entity 710. Alternatively, the second network entity 710 may determine that a default TDD pattern is to be applied during the one or more time intervals.

As shown by reference number 740, the first network entity 705 and the second network entity 710 may communicate one or more messages in accordance with the determined TDD pattern. For example, the first network entity 705 may transmit, and the second network entity 710 may receive, a message in accordance with the determined TDD pattern. Additionally, or alternatively, the second network entity 710 may transmit, and the first network entity 705 may receive, a message in accordance with the determined TDD pattern. Communicating in accordance with a TDD pattern refers to a network entity (e.g., the first network entity 705 or the second network entity 710) communicating based on a transmission direction (e.g., uplink or downlink) that is associated with a given time interval as indicated by the TDD pattern.

For example, the second network entity 710 may determine when to monitoring for scheduling information based on the determined TDD pattern. For example, if the second network entity 710 is a UE, then the second network entity 710 monitor for UE-specific scheduling during downlink time intervals as indicated by the determined TDD pattern. For example, the second network entity 710 may consider uplink time intervals, as indicated by the determined TDD pattern, as time intervals during which the second network entity 710 is to transmit one or more messages. Similarly, the second network entity 710 may consider downlink time intervals, as indicated by the determined TDD pattern, as time intervals during which the second network entity 710 is to monitor for or receive one or more messages. For example, the second network entity 710 may skip, or refrain from, monitoring a downlink control channel (e.g., a PDCCH) in a UE-specific search space (USS) (such as for DCI scrambled with a C-RNTI or a configured scheduling (CS) RNTI) during a time interval indicated as an uplink time interval by the determined TDD pattern.

Additionally, or alternatively, the second network entity 710 may skip, or refrain from, performing a higher layer configured reception or transmission (such as a configured grant reception or transmission, a semi-persistent scheduling (SPS) reception or transmission, an SRS transmission, or a CSI report transmission) if the reception or transmission would cause a collision at the second network entity 710 based on the determined TDD pattern. For example, if the second network entity 710 is configured to transmit a higher layer configured message during a given time interval and the determined TDD pattern indicates that the given time interval is a downlink time interval, then the second network entity 710 may skip, or refrain from, transmitting the message. Similarly, if the second network entity 710 is configured to receive a higher layer configured message during a given time interval and the determined TDD pattern indicates that the given time interval is an uplink time interval, then the second network entity 710 may skip, or refrain from, monitoring for or receiving the message.

The first network entity 705 may determine scheduling information for the second network entity 710 based on the TDD pattern applied by the second network entity 710. For example, the first network entity 705 may determine during which time intervals the second network entity 710 is configured to transmit messages and during which time intervals the second network entity 710 is configured to receive messages based on the TDD pattern. The first network entity 705 may schedule the second network entity 710 accordingly (e.g., may schedule the second network entity 710 to transmit during uplink time intervals and to receive during downlink time intervals).

In some examples, certain types of messages may be communicated for multiple network entities. For example, DCI transmitted by the first network entity 705 in a common search space may be intended for multiple network entities, including the second network entity 710. To ensure that the multiple network entities are able to receive such messages, the first network entity 705 may configure time-frequency resources used to communicate such types of messages during time intervals that are associated with the common TDD pattern. For example, the first network entity 705 may configure a common search space to occur during time intervals that are associated with the common TDD pattern. Correspondingly, the second network entity 710 may monitor the DCI in the common search space according to the common TDD pattern. Alternatively, if the time-frequency resources used to communicate such types of messages occur during the one or more time intervals associated with the multiple TDD patterns, then the second network entity 710 may skip, or refrain from, receiving or monitoring for the messages.

In some examples, random access resources may be configured for the second network entity 710 (e.g., by the first network entity 705). The second network entity 710 may transmit, and the first network entity 705 may receive, a random access message using valid random access resources. The random access resources (e.g., one or more physical random access channel (PRACH) occasions) may be configured to occur periodically over time. In such examples, the second network entity 710 may determine whether a PRACH occasion (e.g., that occurs during a time interval associated with the multiple TDD patterns) is valid based on the determined TDD pattern. For example, if the determined TDD pattern indicates that the time interval is an uplink time interval, then the second network entity 710 may determine that the PRACH occasion is valid. If the determined TDD pattern indicates that the time interval is a downlink time interval, then the second network entity 710 may determine that the PRACH occasion is invalid. For example, only a PRACH occasion within an uplink time interval may be considered as valid for transmitting a PRACH message transmitted by the second network entity 710.

In some examples, if the second network entity 710 determines that a TDD pattern, from the multiple TDD patterns, cannot be determined (e.g., because the second network entity 710 does not have a valid identifier), then the second network entity 710 may skip communication during the one or more time intervals based on the second network entity 710 not being associated with one or more identifiers that are mapped to, or otherwise associated with, the multiple TDD patterns. In such examples, the second network entity 710 may communicate (e.g., transmit or receive) a message during one or more second time intervals that are associated with the common TDD pattern. Alternatively, the first network entity 705 and the second network entity 710 may communicate with each other during the one or more time intervals (e.g., that are associated with the multiple TDD patterns) using a default TDD pattern.

As indicated above, FIG. 7 is provided as an example. Other examples may differ from what is described with respect to FIG. 7.

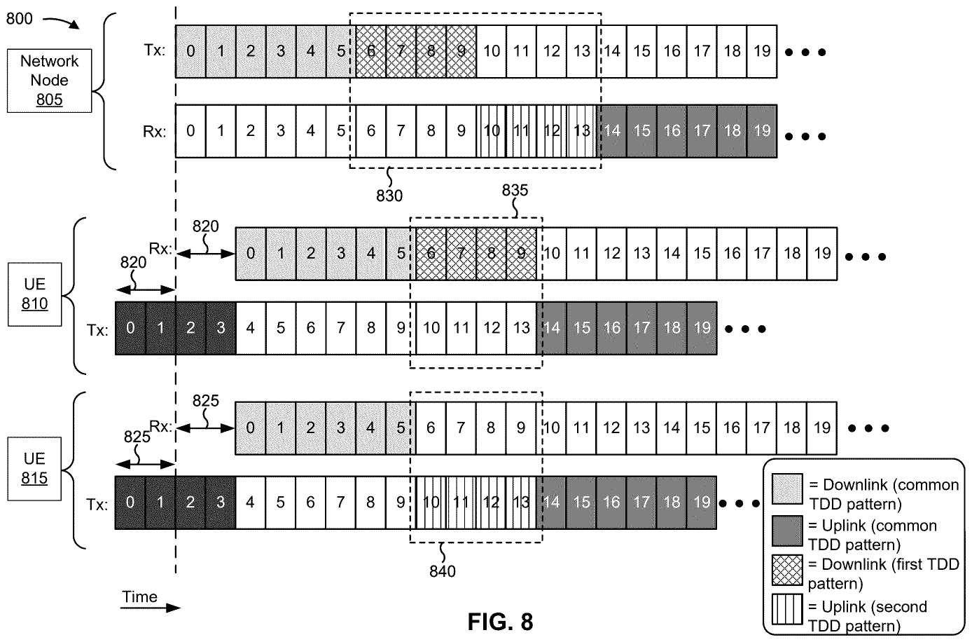

FIG. 8 is a diagram of an example 800 associated with multiple TDD patterns for a time interval. For example, a network node 805 (e.g., the first network entity 705, a network node 210, or an NTN node) may communicate with one or more UEs (e.g., UEs 220), shown in FIG. 8 as a UE 810 and a UE 815. The UE 810 or the UE 815 may be an example of the second network entity 710.

As shown in FIG. 8, uplink transmission timelines and downlink transmission timelines for the one or more UEs may be shifted in time based on a transmission delay (e.g., a TA value or a propagation delay). For example, the UE 810 may shift an uplink transmission timeline and downlink transmission timeline based on a transmission delay 820. Similarly, the UE 815 may shift an uplink transmission timeline and downlink transmission timeline based on a transmission delay 825.

The network node 805 may configure a TDD configuration for the one or more UEs. As shown in FIG. 8, the TDD configuration may indicate a common TDD pattern for one or more time intervals. The one or more time intervals may be the time interval 0 through the time interval 5 and the time interval 14 through the time interval 19, as shown in FIG. 8. For example, the common TDD configuration may indicate that the time interval 0 through the time interval 5 are configured for downlink communication and the time interval 14 through the time interval 19 are configured for uplink communication.

Additionally, the TDD configuration may indicate multiple TDD patterns for one or more time intervals 830. As shown in FIG. 8, the one or more time intervals 830 may include the time interval 6 through the time interval 13. For example, the one or more time intervals 830 may have different TDD patterns or different TDD configurations for the one or more UEs. For example, a first TDD pattern 835 for the UE 810 may indicate that the time interval 6 through the time interval 9 are configured for downlink communication and that the time interval 10 through the time interval 13 are not configured for downlink or uplink communication (e.g., the time interval 6 through the time interval 13 are not available for uplink communication).

A second TDD pattern 840 for the UE 815 may indicate that the time interval 10 through the time 13 are configured for uplink communication and that the time interval 6 through the time interval 9 are not configured for downlink or uplink communication (e.g., the time interval 6 through the time interval 9 are not available for downlink communication). As a result, a resource utilization efficiency for the UE 810 and the UE 815 may be improved. For example, because of the shifts of the uplink transmission timelines and the downlink transmission timelines, both the UE 810 and the UE 815 may utilize time domain resources at a given time instance (e.g., the time interval 6 through the time interval 9 in the downlink transmission timeline and the time interval 10 through the time 13 in the uplink transmission timeline). Additionally, the network node 805 may be able to communicate with the UE 810 and the UE 815 during the given time instance, improving the resource utilization for the network node 805. For example, all the time interval 0 through the time interval 19 are utilized by the network node 805 for communication with the UEs.

As indicated above, FIG. 8 is provided as an example. Other examples may differ from what is described with respect to FIG. 8.

FIG. 9 is a diagram illustrating an example process 900 performed, for example, at a first network entity or an apparatus of a first network entity. Example process 900 is an example where the apparatus or the first network entity (e.g., the second network entity 710 or a UE 220) performs operations associated with multiple TDD patterns for a time interval.

As shown in FIG. 9, in some aspects, process 900 may include receiving a first message that indicates multiple TDD patterns that are each associated with one or more first time intervals, wherein the one or more first time intervals are associated with a periodic pattern (block 910). For example, the first network entity (e.g., using reception component 1102 or communication manager 1106, depicted in FIG. 11) may receive a first message that indicates multiple TDD patterns that are each associated with one or more first time intervals, wherein the one or more first time intervals are associated with a periodic pattern, as described above.

As further shown in FIG. 9, in some aspects, process 900 may include communicating a second message in accordance with a TDD pattern of the multiple TDD patterns (block 920). For example, the first network entity (e.g., using reception component 1102, transmission component 1104, or communication manager 1106, depicted in FIG. 11) may communicate a second message in accordance with a TDD pattern of the multiple TDD patterns, as described above.

Process 900 may include additional aspects, such as any single aspect or any combination of aspects described below or in connection with one or more other processes described elsewhere herein.

In a first aspect, communicating the second message in accordance with the TDD pattern includes communicating the second message during the one or more first time intervals.

In a second aspect, alone or in combination with the first aspect, the first message is a broadcast message.

In a third aspect, alone or in combination with one or more of the first and second aspects, the first message is a system information message.

In a fourth aspect, alone or in combination with one or more of the first through third aspects, communicating the second message in accordance with the TDD pattern includes communicating the second message in accordance with the TDD pattern based on association information that indicates the TDD pattern is associated with the first network entity.

In a fifth aspect, alone or in combination with one or more of the first through fourth aspects, the first message indicates the association information.

In a sixth aspect, alone or in combination with one or more of the first through fifth aspects, the association information indicates that the TDD pattern is associated with the first network entity based on the association information including an indication that an identifier of the first network entity is associated with the TDD pattern.

In a seventh aspect, alone or in combination with one or more of the first through sixth aspects, the identifier is a radio network temporary identifier.

In an eighth aspect, alone or in combination with one or more of the first through seventh aspects, communicating the second message in accordance with the TDD pattern includes communicating the second message in accordance with the TDD pattern based on a rule.

In a ninth aspect, alone or in combination with one or more of the first through eighth aspects, the rule indicates sets of identifiers associated with respective TDD patterns of the multiple TDD patterns, wherein an identifier of the first network entity is included in a set of identifiers from the sets of identifiers, and wherein the rule indicates that the set of identifiers is associated with the TDD pattern.

In a tenth aspect, alone or in combination with one or more of the first through ninth aspects, association information indicates an association between one or more identifiers and respective TDD patterns of the multiple TDD patterns, wherein the first network entity is not associated with the one or more identifiers, and process 900 includes skipping communication during the one or more first time intervals based on the first network entity not being associated with the one or more identifiers.

In an eleventh aspect, alone or in combination with one or more of the first through tenth aspects, communicating the second message in accordance with the TDD pattern includes communicating the second message during one or more second time intervals that are associated with a common TDD pattern.

In a twelfth aspect, alone or in combination with one or more of the first through eleventh aspects, association information indicates an association between one or more identifiers and respective TDD patterns of the multiple TDD patterns, wherein the first network entity is not associated with the one or more identifiers, and wherein the TDD pattern is a default TDD pattern based on the first network entity not being associated with the one or more identifiers.

In a thirteenth aspect, alone or in combination with one or more of the first through twelfth aspects, the first network entity is associated with a transmission delay, and wherein the multiple TDD patterns are based on the transmission delay.

In a fourteenth aspect, alone or in combination with one or more of the first through thirteenth aspects, the transmission delay is a timing advance or a propagation delay.

In a fifteenth aspect, alone or in combination with one or more of the first through fourteenth aspects, process 900 includes receiving an indication of a common TDD pattern associated with one or more second time intervals.

In a sixteenth aspect, alone or in combination with one or more of the first through fifteenth aspects, the first message includes an indication of a common TDD pattern, wherein the common TDD pattern is associated with one or more second time intervals.

In a seventeenth aspect, alone or in combination with one or more of the first through sixteenth aspects, communicating the second message in accordance with the TDD pattern includes transmitting the second message to a second network entity.

In an eighteenth aspect, alone or in combination with one or more of the first through seventeenth aspects, communicating the second message in accordance with the TDD pattern includes receiving the second message from a second network entity.

In a nineteenth aspect, alone or in combination with one or more of the first through eighteenth aspects, communicating the second message in accordance with the TDD pattern includes communicating the second message via an NTN.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network entity or an apparatus of a first network entity. Example process 1000 is an example where the apparatus or the first network entity (e.g., the first network entity 705, a network node 210, or an NTN entity) performs operations associated with multiple TDD patterns for a time interval.

As shown in FIG. 10, in some aspects, process 1000 may include transmitting a first message that indicates multiple TDD patterns that are each associated with one or more first time intervals, wherein the one or more first time intervals are associated with a periodic pattern (block 1010). For example, the first network entity (e.g., using transmission component 1204 or communication manager 1206, depicted in FIG. 12) may transmit a first message that indicates multiple TDD patterns that are each associated with one or more first time intervals, wherein the one or more first time intervals are associated with a periodic pattern, as described above.

As further shown in FIG. 10, in some aspects, process 1000 may include communicating a second message, associated with a second network entity, in accordance with a TDD pattern of the multiple TDD patterns (block 1020). For example, the first network entity (e.g., using reception component 1202, transmission component 1204, or communication manager 1206, depicted in FIG. 12) may communicate a second message, associated with a second network entity, in accordance with a TDD pattern of the multiple TDD patterns, as described above.

Process 1000 may include additional aspects, such as any single aspect or any combination of aspects described below or in connection with one or more other processes described elsewhere herein.

In a first aspect, communicating the second message in accordance with the TDD pattern includes communicating the second message during the one or more first time intervals.

In a second aspect, alone or in combination with the first aspect, the first message is a broadcast message.

In a third aspect, alone or in combination with one or more of the first and second aspects, the first message is a system information message.

In a fourth aspect, alone or in combination with one or more of the first through third aspects, communicating the second message in accordance with the TDD pattern includes communicating the second message in accordance with the TDD pattern based on association information that indicates the TDD pattern is associated with the second network entity.

In a fifth aspect, alone or in combination with one or more of the first through fourth aspects, the first message indicates the association information.

In a sixth aspect, alone or in combination with one or more of the first through fifth aspects, the association information indicates that the TDD pattern is associated with the second network entity based on the association information including an indication that an identifier of the second network entity is associated with the TDD pattern.

In a seventh aspect, alone or in combination with one or more of the first through sixth aspects, the identifier is a radio network temporary identifier.

In an eighth aspect, alone or in combination with one or more of the first through seventh aspects, communicating the second message in accordance with the TDD pattern includes communicating the second message in accordance with the TDD pattern based on a rule.

In a ninth aspect, alone or in combination with one or more of the first through eighth aspects, the rule indicates sets of identifiers associated with respective TDD patterns of the multiple TDD patterns, wherein an identifier of the second network entity is included in a set of identifiers from the sets of identifiers, and wherein the rule indicates that the set of identifiers is associated with the TDD pattern.

In a tenth aspect, alone or in combination with one or more of the first through ninth aspects, association information indicates an association between one or more identifiers and respective TDD patterns of the multiple TDD patterns, wherein the second network entity is not associated with the one or more identifiers, and process 1000 includes skipping communication with the second network entity during the one or more first time intervals based on the second network entity not being associated with the one or more identifiers.

In an eleventh aspect, alone or in combination with one or more of the first through tenth aspects, communicating the second message in accordance with the TDD pattern includes communicating the second message during one or more second time intervals that are associated with a common TDD pattern.

In a twelfth aspect, alone or in combination with one or more of the first through eleventh aspects, association information indicates an association between one or more identifiers and respective TDD patterns of the multiple TDD patterns, wherein the second network entity is not associated with the one or more identifiers, and wherein the TDD pattern is a default TDD pattern based on the second network entity not being associated with the one or more identifiers.

In a thirteenth aspect, alone or in combination with one or more of the first through twelfth aspects, the multiple TDD patterns are associated with a coverage area, wherein the coverage area is associated with one or more transmission delays, and wherein the multiple TDD patterns are associated with the one or more transmission delays.

In a fourteenth aspect, alone or in combination with one or more of the first through thirteenth aspects, the one or more transmission delays are one or more timing advances or one or more propagation delays.

In a fifteenth aspect, alone or in combination with one or more of the first through fourteenth aspects, process 1000 includes transmitting an indication of a common TDD pattern associated with one or more second time intervals.

In a sixteenth aspect, alone or in combination with one or more of the first through fifteenth aspects, the first message includes an indication of a common TDD pattern, and wherein the common TDD pattern is associated with one or more second time intervals.

In a seventeenth aspect, alone or in combination with one or more of the first through sixteenth aspects, communicating the second message in accordance with the TDD pattern includes transmitting the second message.

In an eighteenth aspect, alone or in combination with one or more of the first through seventeenth aspects, communicating the second message in accordance with the TDD pattern includes receiving the second message.

In a nineteenth aspect, alone or in combination with one or more of the first through eighteenth aspects, communicating the second message in accordance with the TDD pattern includes communicating the second message via an NTN.

In a twentieth aspect, alone or in combination with one or more of the first through nineteenth aspects, communicating the second message in accordance with the TDD pattern includes communicating, during the one or more first time intervals, multiple communications associated with respective TDD patterns of the multiple TDD patterns, wherein the multiple communications include the second communication, and wherein the multiple communications are associated with respective network entities including the second network entity.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network entity, or a network entity may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 114, the communication manager 118, or the communication manager 250. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, or the processing system 240).

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components described in connection with FIGS. 1-3. Additionally, or alternatively, one or more components shown in FIG. 11 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components described above in connection with FIGS. 1-3, such as a radio, one or more RF chains, one or more transceivers, or one or more modems, each of which may in turn be coupled with one or more antennas of the network entity.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive a first message that indicates multiple TDD patterns that are each associated with one or more first time intervals, wherein the one or more first time intervals are associated with a periodic pattern. The reception component 1102 or the transmission component 1104 may communicate a second message in accordance with a TDD pattern of the multiple TDD patterns.

The reception component 1102 may receive an indication of a common TDD pattern associated with one or more second time intervals.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 114, the communication manager 118, or the communication manager 255. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 110, the processing system 112, or the processing system 245).

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10, or a combination thereof. In some aspects, the apparatus 1200 or one or more components shown in FIG. 12 may include one or more components described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIGS. 1-3, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit a first message that indicates multiple TDD patterns that are each associated with one or more first time intervals, wherein the one or more first time intervals are associated with a periodic pattern. The reception component 1202 or the transmission component 1204 may communicate a second message, associated with a second network entity, in accordance with a TDD pattern of the multiple TDD patterns.

The transmission component 1204 may transmit an indication of a common TDD pattern associated with one or more second time intervals.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first network entity, comprising: receiving a first message that indicates multiple time division duplex (TDD) patterns that are each associated with one or more first time intervals, wherein the one or more first time intervals are associated with a periodic pattern; and communicating a second message in accordance with a TDD pattern of the multiple TDD patterns.

Aspect 2: The method of Aspect 1, wherein communicating the second message in accordance with the TDD pattern comprises communicating the second message during the one or more first time intervals.

Aspect 3: The method of any of Aspects 1-2, wherein the first message is a broadcast message.

Aspect 4: The method of any of Aspects 1-3, wherein the first message is a system information message.

Aspect 5: The method of any of Aspects 1-4, wherein communicating the second message in accordance with the TDD pattern comprises communicating the second message in accordance with the TDD pattern based on association information that indicates the TDD pattern is associated with the first network entity.

Aspect 6: The method of Aspect 5, wherein the first message indicates the association information.

Aspect 7: The method of any of Aspects 5-6, wherein the association information indicates that the TDD pattern is associated with the first network entity based on the association information including an indication that an identifier of the first network entity is associated with the TDD pattern.

Aspect 8: The method of Aspect 7, wherein the identifier is a radio network temporary identifier.

Aspect 9: The method of any of Aspects 1-8, wherein communicating the second message in accordance with the TDD pattern comprises communicating the second message in accordance with the TDD pattern based on a rule.

Aspect 10: The method of Aspect 9, wherein the rule indicates sets of identifiers associated with respective TDD patterns of the multiple TDD patterns, wherein an identifier of the first network entity is included in a set of identifiers from the sets of identifiers, and wherein the rule indicates that the set of identifiers is associated with the TDD pattern.

Aspect 11: The method of any of Aspects 1-10, wherein association information indicates an association between one or more identifiers and respective TDD patterns of the multiple TDD patterns, wherein the first network entity is not associated with the one or more identifiers, and the method further comprising skipping communication during the one or more first time intervals based on the first network entity not being associated with the one or more identifiers.

Aspect 12: The method of Aspect 11, wherein communicating the second message in accordance with the TDD pattern comprises: communicating the second message during one or more second time intervals that are associated with a common TDD pattern.

Aspect 13: The method of any of Aspects 1-12, wherein association information indicates an association between one or more identifiers and respective TDD patterns of the multiple TDD patterns, wherein the first network entity is not associated with the one or more identifiers, and wherein the TDD pattern is a default TDD pattern based on the first network entity not being associated with the one or more identifiers.

Aspect 14: The method of any of Aspects 1-13, wherein the first network entity is associated with a transmission delay, and wherein the multiple TDD patterns are based on the transmission delay.

Aspect 15: The method of Aspect 14, wherein the transmission delay is a timing advance or a propagation delay.

Aspect 16: The method of any of Aspects 1-15, further comprising receiving an indication of a common TDD pattern associated with one or more second time intervals.

Aspect 17: The method of any of Aspects 1-16, wherein the first message includes an indication of a common TDD pattern, wherein the common TDD pattern is associated with one or more second time intervals.

Aspect 18: The method of any of Aspects 1-17, wherein communicating the second message in accordance with the TDD pattern comprises transmitting the second message to a second network entity.

Aspect 19: The method of any of Aspects 1-18, wherein communicating the second message in accordance with the TDD pattern comprises receiving the second message from a second network entity.

Aspect 20: The method of any of Aspects 1-19, wherein communicating the second message in accordance with the TDD pattern comprises communicating the second message via a non-terrestrial network (NTN).

Aspect 21: A method of wireless communication performed by a first network entity, comprising: transmitting a first message that indicates multiple time division duplex (TDD) patterns that are each associated with one or more first time intervals, wherein the one or more first time intervals are associated with a periodic pattern; and communicating a second message, associated with a second network entity, in accordance with a TDD pattern of the multiple TDD patterns.

Aspect 22: The method of Aspect 21, wherein communicating the second message in accordance with the TDD pattern comprises communicating the second message during the one or more first time intervals.

Aspect 23: The method of any of Aspects 21-22, wherein the first message is a broadcast message.

Aspect 24: The method of any of Aspects 21-23, wherein the first message is a system information message.

Aspect 25: The method of any of Aspects 21-24, wherein communicating the second message in accordance with the TDD pattern comprises communicating the second message in accordance with the TDD pattern based on association information that indicates the TDD pattern is associated with the second network entity.

Aspect 26: The method of Aspect 25, wherein the first message indicates the association information.

Aspect 27: The method of any of Aspects 25-26, wherein the association information indicates that the TDD pattern is associated with the second network entity based on the association information including an indication that an identifier of the second network entity is associated with the TDD pattern.

Aspect 28: The method of Aspect 27, wherein the identifier is a radio network temporary identifier.

Aspect 29: The method of any of Aspects 21-28, wherein communicating the second message in accordance with the TDD pattern comprises communicating the second message in accordance with the TDD pattern based on a rule.

Aspect 30: The method of Aspect 29, wherein the rule indicates sets of identifiers associated with respective TDD patterns of the multiple TDD patterns, wherein an identifier of the second network entity is included in a set of identifiers from the sets of identifiers, and wherein the rule indicates that the set of identifiers is associated with the TDD pattern.

Aspect 31: The method of any of Aspects 21-30, wherein association information indicates an association between one or more identifiers and respective TDD patterns of the multiple TDD patterns, wherein the second network entity is not associated with the one or more identifiers, and the method further comprising skipping communication with the second network entity during the one or more first time intervals based on the second network entity not being associated with the one or more identifiers.

Aspect 32: The method of Aspect 31, wherein communicating the second message in accordance with the TDD pattern comprises: communicating the second message during one or more second time intervals that are associated with a common TDD pattern.

Aspect 33: The method of any of Aspects 21-32, wherein association information indicates an association between one or more identifiers and respective TDD patterns of the multiple TDD patterns, wherein the second network entity is not associated with the one or more identifiers, and wherein the TDD pattern is a default TDD pattern based on the second network entity not being associated with the one or more identifiers.

Aspect 34: The method of any of Aspects 21-33, wherein the multiple TDD patterns are associated with a coverage area, wherein the coverage area is associated with one or more transmission delays, and wherein the multiple TDD patterns are associated with the one or more transmission delays.

Aspect 35: The method of Aspect 34, wherein the one or more transmission delays are one or more timing advances or one or more propagation delays.

Aspect 36: The method of any of Aspects 21-35, further comprising transmitting an indication of a common TDD pattern associated with one or more second time intervals.

Aspect 37: The method of any of Aspects 21-36, wherein the first message includes an indication of a common TDD pattern, and wherein the common TDD pattern is associated with one or more second time intervals.

Aspect 38: The method of any of Aspects 21-37, wherein communicating the second message in accordance with the TDD pattern comprises transmitting the second message.

Aspect 39: The method of any of Aspects 21-38, wherein communicating the second message in accordance with the TDD pattern comprises receiving the second message.

Aspect 40: The method of any of Aspects 21-39, wherein communicating the second message in accordance with the TDD pattern comprises communicating the second message via a non-terrestrial network (NTN).

Aspect 41: The method of any of Aspects 21-40, wherein communicating the second message in accordance with the TDD pattern comprises: communicating, during the one or more first time intervals, multiple communications associated with respective TDD patterns of the multiple TDD patterns, wherein the multiple communications include the second communication, and wherein the multiple communications are associated with respective network entities including the second network entity.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.

Aspect 43: An apparatus for wireless communication at a device, the apparatus comprising one or more memories and one or more processors coupled to the one or more memories, the one or more processors configured to cause the device to perform the method of one or more of Aspects 1-41.

Aspect 44: An apparatus for wireless communication, the apparatus comprising at least one means for performing the method of one or more of Aspects 1-41.

Aspect 45: A non-transitory computer-readable medium storing code for wireless communication, the code comprising instructions executable by one or more processors to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

Aspect 47: A device for wireless communication, the device comprising a processing system that includes one or more processors and one or more memories coupled with the one or more processors, the processing system configured to cause the device to perform the method of one or more of Aspects 1-41.

Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.

Aspect 49: A device comprising a processing system that includes one or more processors and one or more code-storing memories coupled with the one or more processors, the processing system configured to cause the device to perform the method of one or more of Aspects 1-41.

Aspect 50: A device comprising a processing system that includes processor circuitry and code-storing memory circuitry, the processing system configured to cause the device to perform the method of one or more of Aspects 1-41.

Aspect 51: A device for wireless communication, the device comprising a processing system, the processing system configured to perform the method of one or more of Aspects 1-41.

Aspect 52: A non-transitory computer-readable medium having code thereon that, when executed by a device, causes the device to perform the method of one or more of Aspects 1-41.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
receive a first message that indicates multiple time division duplex (TDD) patterns that are each associated with one or more first time intervals, wherein the one or more first time intervals are associated with a periodic pattern; and
communicate a second message in accordance with a TDD pattern of the multiple TDD patterns.

2. The first network entity of claim 1, wherein the processing system is configured to communicate the second message during the one or more first time intervals.

3. The first network entity of claim 1, wherein the first message is a broadcast message.

4. The first network entity of claim 1, wherein the first message is a system information message.

5. The first network entity of claim 1, wherein, to communicate the second message in accordance with the TDD pattern, the processing system is configured to communicate the second message in accordance with the TDD pattern based on association information that indicates the TDD pattern is associated with the first network entity.

6. The first network entity of claim 5, wherein the first message indicates the association information.

7. The first network entity of claim 5, wherein the association information indicates that the TDD pattern is associated with the first network entity based on the association information including an indication that an identifier of the first network entity is associated with the TDD pattern.

8. The first network entity of claim 7, wherein the identifier is a radio network temporary identifier.

9. The first network entity of claim 1, wherein, to communicate the second message in accordance with the TDD pattern, the processing system is configured to communicate the second message in accordance with the TDD pattern based on a rule.

10. The first network entity of claim 9, wherein the rule indicates sets of identifiers associated with respective TDD patterns of the multiple TDD patterns, wherein an identifier of the first network entity is included in a set of identifiers from the sets of identifiers, and wherein the rule indicates that the set of identifiers is associated with the TDD pattern.

11. The first network entity of claim 1, wherein association information indicates an association between one or more identifiers and respective TDD patterns of the multiple TDD patterns, wherein the first network entity is not associated with the one or more identifiers, and wherein the processing system is configured to skip communication during the one or more first time intervals based on the first network entity not being associated with the one or more identifiers.

12. The first network entity of claim 11, wherein, to communicate the second message, the processing system is configured to:
communicate the second message during one or more second time intervals that are associated with a common TDD pattern.

13. The first network entity of claim 1, wherein association information indicates an association between one or more identifiers and respective TDD patterns of the multiple TDD patterns, wherein the first network entity is not associated with the one or more identifiers, and wherein the TDD pattern is a default TDD pattern based on the first network entity not being associated with the one or more identifiers.

14. The first network entity of claim 1, wherein the processing system is configured to receive an indication of a common TDD pattern associated with one or more second time intervals.

15. The first network entity of claim 1, wherein the first message includes an indication of a common TDD pattern, wherein the common TDD pattern is associated with one or more second time intervals.

16. The first network entity of claim 1, wherein, to communicate the second message, the processing system is configured to communicate the second message via a non-terrestrial network (NTN).

17. A first network entity, comprising:
a processing system configured to:
transmit a first message that indicates multiple time division duplex (TDD) patterns that are each associated with one or more first time intervals, wherein the one or more first time intervals are associated with a periodic pattern; and
communicate a second message, associated with a second network entity, in accordance with a TDD pattern of the multiple TDD patterns.

18. The first network entity of claim 17, wherein the processing system is configured to communicate the second message during the one or more first time intervals.

19. The first network entity of claim 17, wherein, to communicate the second message in accordance with the TDD pattern, the processing system is configured to communicate the second message in accordance with the TDD pattern based on association information that indicates the TDD pattern is associated with the second network entity.

20. The first network entity of claim 19, wherein the first message indicates the association information.

21. The first network entity of claim 19, wherein the association information indicates that the TDD pattern is associated with the second network entity based on the association information including an indication that an identifier of the second network entity is associated with the TDD pattern.

22. The first network entity of claim 19, wherein, to communicate the second message in accordance with the TDD pattern, the processing system is configured to communicate the second message in accordance with the TDD pattern based on a rule.

23. The first network entity of claim 22, wherein the rule indicates sets of identifiers associated with respective TDD patterns of the multiple TDD patterns, wherein an identifier of the second network entity is included in a set of identifiers from the sets of identifiers, and wherein the rule indicates that the set of identifiers is associated with the TDD pattern.

24. The first network entity of claim 19, wherein association information indicates an association between one or more identifiers and respective TDD patterns of the multiple TDD patterns, wherein the second network entity is not associated with the one or more identifiers, and wherein the processing system is configured to skip communication with the second network entity during the one or more first time intervals based on the second network entity not being associated with the one or more identifiers.

25. The first network entity of claim 24, wherein, to communicate the second message, the processing system is configured to:
communicate the second message during one or more second time intervals that are associated with a common TDD pattern.

26. The first network entity of claim 17, wherein association information indicates an association between one or more identifiers and respective TDD patterns of the multiple TDD patterns, wherein the second network entity is not associated with the one or more identifiers, and wherein the TDD pattern is a default TDD pattern based on the second network entity not being associated with the one or more identifiers.

27. The first network entity of claim 17, wherein the multiple TDD patterns are associated with a coverage area, wherein the coverage area is associated with one or more transmission delays, and wherein the multiple TDD patterns are associated with the one or more transmission delays.

28. The first network entity of claim 27, wherein the one or more transmission delays are one or more timing advances or one or more propagation delays.
